(19) United States
(12) Patent Application Publication
(10) Pub. No.: US 2009/0234729 A1
(43) Pub. Date: Sep. 17, 2009

(54) MANAGEMENT OF A USER ATTRIBUTE IN A SERVICE PROVIDER DATA STRUCTURE

(75) Inventors: Gregory J. Boss, American Fork, UT (US); Andrew R. Jones, Round Rock, TX (US); Michael J. Martine, Chapel Hill, NC (US); Kevin C. McConnell, Austin, TX (US)

Correspondence Address: Caesar, Rivise, Bernstein, Cohen & Pokotilow Ltd., 11th Floor, Seven Penn Center, Philadelphia, PA, 19103, US

(73) Assignee: INTERNATIONAL BUSINESS MACHINES CORPORATION, Armonk, NY (US)

(21) Appl. No.: 12/048,552

(22) Filed: Mar. 14, 2008

(51) Int. Cl. G06Q 30/00; G06F 17/30

(52) U.S. Cl. 705/14; 707/100; 707/E17.005

(57) ABSTRACT

A method for managing an attribute of a user of a service provided by a service provider, the user having a user computing device and the service provider having a service provider computing device, includes providing a user attribute management data structure within the service provider computing device, providing interaction between the user attribute management data structure and the user using the user computing device, and altering the user attribute management data structure using the service provider computing device in accordance with the interacting. The method includes inserting the user into the data structure, altering a place in line attribute representative of a user place in a line waiting for the service. Further altering the attribute by the user, further altering the attribute by the service provider and further altering the attribute in accordance with a service provider criterion are also included.

### BACKGROUND OF THE INVENTION

This invention relates to the field of data structures and, in particular, to the field of managing a data structure.

### BACKGROUND OF THE INVENTION

Users of many services are often required to wait until they arrive at the location where the services are performed before being able to get in line to receive the service. For example, individuals en route to an entertainment event or a government office may not be able to get in line for the service until they arrive. More significantly, sometimes it is not possible to determine whether the service is available until arrival. For example, a user may arrive at a stadium and discover that all seats are taken or at government office and learn that the wait time extends past the office closing time. In another example, a user can enter a parking lot and discover that the parking lot is full.

For other services, it may be easier to determine whether the service is available prior to arrival or to get a reservation for the service before arrival. For example, it is possible to place a telephone call to a restaurant or a hair salon, determine whether the service is available, and request a reservation prior to arrival. However, even in the latter cases, the process of determining whether the service is available and making a reservation can be unnecessarily time consuming and labor intensive.

In one known solution to these problems a service provider can provide a data structure for managing users waiting for the service and permit the users to access the data structures from a remote location. For example, it is possible for a user to access a first-in first-out service provider queue and request insertion into the queue. When a service provider makes such a queue available, the user can sometimes view the queue and determine a place in line to receive the service. Accordingly, the user can determine if the wait time for the service is acceptable prior to arrival. Furthermore, it is known to permit users to request and obtain information about a service that could be useful in deciding whether to make such arrangements.

For example, U.S. Patent Publication No. US 2006/0195510 A1 entitled “Information Management and Synchronous Communications System” filed by Keith R. McNally and published on Aug. 31, 2006 discloses a communication system for facilitating communication between wired or wireless web based systems and restaurants or point of sale terminals. The web based systems taught by McNally can perform remote data entry and can make reservations or appointments. Furthermore, the McNally system can obtain information regarding reservations or appointments.

U.S. Pat. No. 7,216,109 entitled “System and Method for Reallocating and/or Upgrading and/or Selling Tickets, Other Events Admittance Means, Goods and/or Services” issued to Irah H. Donner on May 18, 2007 teaches a server architecture for permitting users to access events by way of a data communications network. In the Donner system the customer can obtain access to a point of sale system when the request for access is verified. Additionally, customers for the event can be notified to perform upgrades and reallocations of arrangements made by way of the data communications network.

U.S. Pat. No. 5,948,040 issued to David M. DeLorme on Sep. 7, 1999 teaches a computerized travel reservation and planning system. The DeLorme system permits a user to obtain guidance and perform transactions on route to an event. Communication links are provided to the user in order to permit the user to obtain supplemental information on places, times, topics and other goods and service offers. Furthermore, users can engage in an iterative planning process wherein they can revise and edit travel plans as they obtain more information.

U.S. Patent Publication No. US 2007/0168215 A1 entitled “Voice Controlled Business Scheduling System and Method” filed by Yilissa Tang and published on Jul. 19, 2007 teaches a voice controlled business appointment/reservation system. The Tang system permits a user to make appointments and reservations. Additionally, the Tang system includes an ability to remotely search and reserve available time slots based on customer preferences.

Thus, it is known for a user to be able to contact a service provider from a remote location to make a reservation or an appointment or to engage in a transaction. However, the known art does not provide the ability to interactively engage a service provider or other users of a service provider in order to adjust and revise user attributes recognized by the service provider.

### BRIEF SUMMARY OF THE INVENTION

A method for managing an attribute of a user of a service provided by a service provider, the user having a user computing device and the service provider having a service provider computing device, includes providing a user attribute management data structure within the service provider computing device, providing interaction between the user attribute management data structure and the user using the user computing device, and altering the user attribute management data structure using the service provider computing device in accordance with the interacting.

The method includes inserting the user into the user attribute management data structure, altering a place in line attribute representative of a user place in a line waiting for the service. Further altering the place in line attribute by the user, further altering the place in line attribute by the service provider and further altering the place in line attribute in accordance with a service provider criterion are also included.

The user interacts with the user attribute management data structure by way of a broker and the service provider registers with the broker. The broker sends the user request to the service provider according to the registration. The user provides a user parameter and the user parameter is a time parameter, a geographic location parameter or a price parameter. The user attribute management data structure is altered in accordance with the parameter, a service provider offer is generated by the service provider in accordance with the user request and the service provider request is accepted or rejected by the user. The service provider can generate a new offer in response to the user rejecting the service provider request. The user attribute is altered according to the request by the user and by the service provider. The user attribute management data structure is altered in accordance with the determined attribute criterion.

A method for managing an attribute of a user of a service provided by a service provider includes providing a service provider computing device for storing a user attribute management data structure to manage a user attribute within the user attribute management data structure, interacting with the user by the service provider computing device and altering the user attribute by the service provider computing device in accordance with the interacting.

### BRIEF DESCRIPTION OF THE DRAWINGS

The invention will be described in conjunction with the following drawings in which like numbers designate like elements and wherein:

FIGS. 1-4 show portions of a process flow representation of a system and method for management of a queue.

FIG. 5 shows a process flow representation of a user queue negotiation process which can be used in connection with the system and method for management of in-queue systems of FIGS. 1-4.

FIG. 6 shows a process flow representation of a service provider queue negotiation process which can be used in connection with the system and method for management of in-queue systems of FIGS. 1-4.

FIG. 7 shows a process flow representation of a queue repositioning process which can be used in connection with the system and method for management of in-queue systems of FIGS. 1-4.

### DETAILED DESCRIPTION

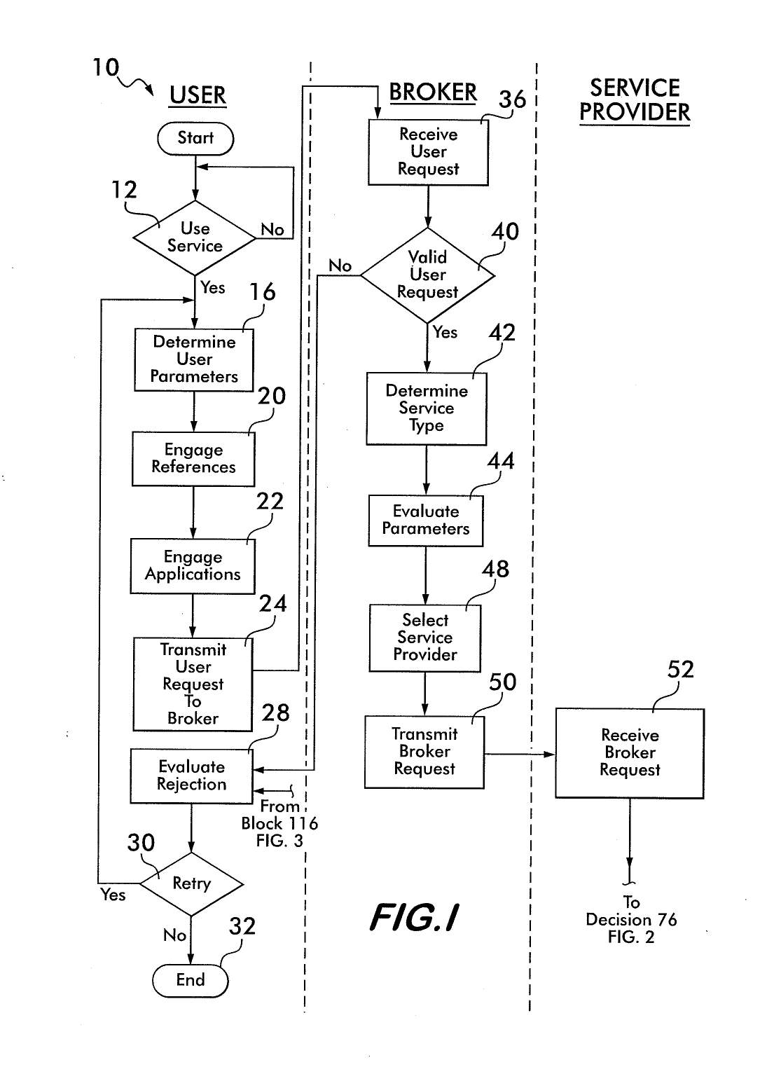

Referring now to FIGS. 1-4, there is shown a process flow representation of a service provider data structure management system 10. The data structure management system 10 permits users or potential users of services having a service provider data structure to interact with and manage the service provider data structure. While the invention may be described with respect to a queue data structure for convenience, it will be understood by those skilled in the art that the data structure managed using the data structure management system 10 can be any kind of data structure for organizing users or potential users of a service. Furthermore, while the data structure management system 10 may be described with respect to managing a place in line for a user waiting for the service relative to others in line for the service, it will be understood any attribute of a user can be managed using the system 10. For example, the data structure management system 10 can manage a user status such as a preferred user status or as a frequent user status.

As shown in decision 12 a user of the data structure management system 10 can decide whether to use a service having a data structure which can be managed by the data structure management system 10. If the user decides to use the service, the user can determine the parameters of the use as shown in block 16. The data structure management system 10 permits the user to obtain a list of service providers filtered to include the services that meet the parameters specified by the user in block 16.

For example, in block 16 the user can instruct the data structure management system 10 to return only services provided within a specified geographic limit. Accordingly, the user can use parameters entered in block 16 request a list of providers of the desired service within a five mile radius, a ten mile radius, or any other radius of a specified location. If the user requests theater tickets or tickets to a sporting event, the user can specify dates, times or preferred seating locations within a theater or stadium in block 16.

Alternately, the user can enter parameters specifying a maximum acceptable wait time for service in block 16. Therefore, the data structure management system 10 can return a list of services that are available within a specified period of time. For example, the user can indicate a willingness to wait ten minutes, fifteen minutes or any other time period. The time period can begin at the time the user accesses the data structure or at the time the user arrives at the location where the service is performed. The user can also specify a list of service providers providing the requested services within a specified price range. For example, the data structure management system 10 can permit a user to indicate low, moderate or high price ranges according to an understood relative rating method. Furthermore, the user can select the services according to any other parameters that are relevant to the requested service in block 16.

Additionally, the user can specify combinations of parameters within block 16 of the data structure management system 10. For example, the user of the data structure management system 10 can request a list of service providers within a specified geographic limit, which are available within a specified period of time, and within a specified price range. Furthermore, the user can engage and access reference sources as shown in block 20. The reference sources accessed in block 20 can be any reference sources available on the internet or from any other repositories of information. For example, the user can access lists of sporting events, lists of restaurants and restaurant reviews, movie theaters and movie reviews, plays and play reviews, or any other review or rating for any other type of service. As shown in block 22 the user can engage applications within the data structure management system 10. The applications engaged in block 22 can include applications such as Global Positioning System (GPS) applications, search engines, interactive rating services, etc.

In one preferred embodiment of the invention a user can specify alternate choices. For example, the user can specify two different locations in a theater or two different show times. Additionally, the user can specify preferences or priorities for the multiple choices. Furthermore, a user can indicate a user status, such as the status of a preferred customer or a frequent customer. Accordingly, in block 16, a user can specify any user attributes recognized by a service provider.

When a user formulates a service request within the data structure management system 10, the user can transmit the service request to a broker as shown block 24. The broker can be an organization having a computing device for interfacing users of the data structure management system 10 with any service providers having queues that can be managed using the data structure management system 10. In a preferred embodiment of the invention a service provider wishing to allow a potential customer to manage its service provider queue using the data structure management system 10 can register with a broker prior to access by a user.

For example, prior to a user service request a service provider can enter into a relationship with the broker wherein the broker can receive a percentage of the revenues received by the service provider as a result of business the service provider receives by way of the data structure management system 10. In an alternate embodiment of the data structure management system 10 a broker can contact a service provider, or a service provider can contact a broker, in order to register with each other. Accordingly, they can make arrangements with each other to manage a user request.

A user who wants to receive the services of the broker to obtain access to a service provider queue using the data structure management system 10 can engage the broker prior to the time of access to the service. For example, a user can engage a broker on a periodic subscription basis, on a per use basis, or on any other basis agreeable to the user, the broker or the service provider. In an alternate embodiment, a user can interact with any other entity useful for facilitating interaction between the user and a service provider. In a further alternate embodiment, a user can interact with a service provider directly without the services of a broker. For example, a service provider can provide access to a service provider queue within its website. Accordingly, the user can visit the website and navigate to the queue in order to manage the queue. In another alternate embodiment, a user can engage a broker at the time of a user access. Furthermore, in one preferred embodiment the same entity can serve as both the broker and the service provider.

As shown in block 36 of the data structure management system 10, the broker can receive the user request transmitted in block 24. In one embodiment of the data structure management system 10, the broker can post a request at a location known to potential service providers. The posting can indicate that a user has requested a service and permit the service providers to search for such postings and respond to them. A broker receiving the user request can then make a determination whether the user request received in block 36 is a valid request as shown in decision 40. If the user request is not valid the broker can reject the request and return it to the user as shown in block 28. The user can evaluate the request rejection in block 28 and make a determination whether to make another request as shown in decision 30. If the user decides to make another request, the user can return to block 16, determine new user parameters and transmit the new request as shown in block 24. If the user decides not to make another request the data structure management system 10 can end as shown in block 32.

When transmitting a new request to a broker or a service provider according to block 24, the user can request a change to any user attribute recognized by the service provider including any user attribute associated with a previous request. For example, a user can specify a single reservation, alternate reservations with or without priorities, or even a different service. Furthermore, the user is not limited to specifying new parameters when a previous request is rejected. For example, a user having a reservation scheduled for one time can send a transmission cancelling the scheduled reservation and requesting a different service. The user can formulate and transmit a new request at any time after the first transmission.

If a user request is valid, as determined in decision 40, the broker can determine the type of service requested as shown in block 42. For example, the broker can determine that the request is a request for a restaurant reservation and review the restaurant services registered with the broker. Alternately, the broker can determine that the request is a request for a show, a concert, a movie, a sporting event, a salon, a medical office, a government office such as a post office or a social security office, a retail outlet, or any other type of service in block 42 and review the corresponding registered services.

In a preferred embodiment of the invention the service provider of the data structure management system 10 may not be a commercial or governmental entity available to public users. For example, the service provider can provide a service internally to other parts of an entity such as a company or a government office. Accordingly, the data structure management system 10 can manage access to services such as maintenance services, supply services or any other services within an organization.

Furthermore, the user of the data structure management system 10 is not necessarily a patron or potential patron of a service provider. The user can be a person authorized by a patron to act on behalf of the patron or any other entity interested in viewing or managing a service provider queue. Additionally, the user is not required to be a consumer end point user. The user can be, for example, an internal part of an organization such as a governmental organization or a commercial organization as previously described.

As shown in block 44, the broker can evaluate any parameters provided by the user in block 16. Furthermore, the broker can select a registered service provider or assemble a list of registered service providers according to the parameters, as shown in block 48. For example, in block 48 the broker can select a list of registered restaurant services within a specified distance from the user and within a specified price range according to the parameters evaluated in block 44. The broker can then transmit a broker request to one or more of the selected service providers as shown in block 50. As shown in block 52 a service provider can receive a broker request transmitted by the broker in block 50.

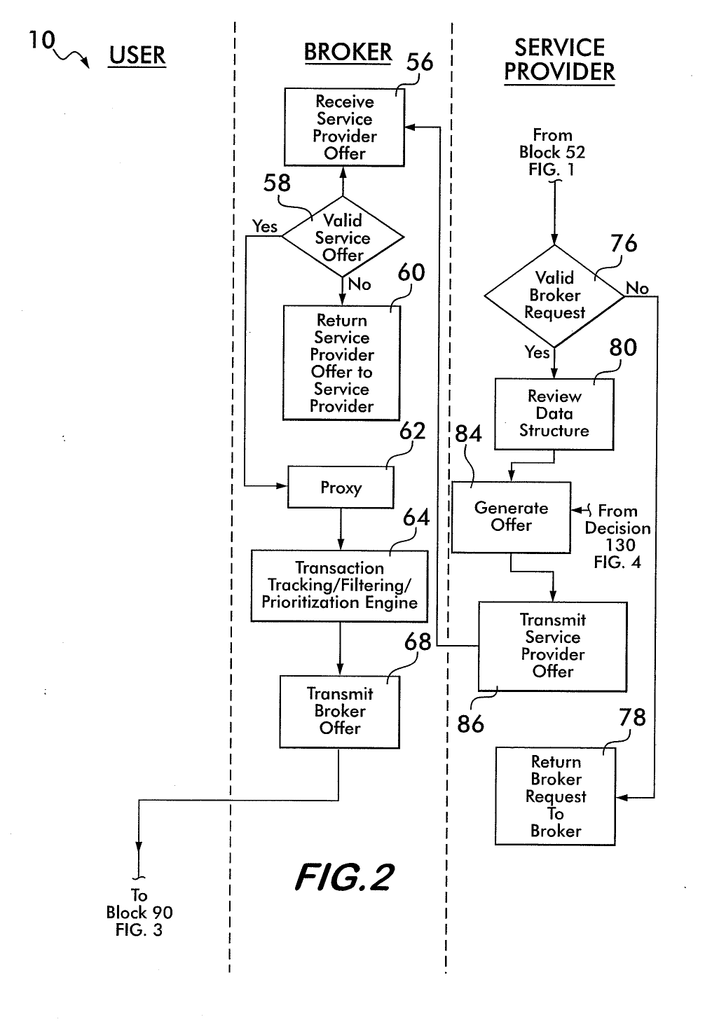

With reference to column 3 of FIG. 2, the service provider can make a determination whether the broker request transmitted by the broker in block 50 is a valid broker request within the data structure management system 10, as shown in decision 76. If the broker request is not valid, the service provider can return it to the broker as shown in block 78.

If the broker request is valid, as determined in decision 76, the service provider can review the queue to be accessed by the user of the data structure management system 10, as shown in block 80. The review performed by the service provider according to block 80 can be a review to determine whether the requested service is available for use by the user according to the user supplied parameters. For example, a provider of a restaurant service can determine whether a specified number of diners can be seated and served according to the parameters of the request transmitted by the user to the broker in block 24. A provider of theater services can determine whether the requested number of tickets for a performance is available as indicated by the parameters transmitted by the user.

As shown in block 84 the service provider can generate an offer for the user based on the user specified parameters and the availability of the service. The service provider can transmit the service provider offer as shown in block 86. In one embodiment of the invention the broker can receive the service provider offer as shown in block 56 and make a determination whether the service provider offer is valid as shown in decision 58. Furthermore, the broker can receive multiple service provider offers in block 56 if a service provider is assembling a list of service providers. If a service provider offer is not valid, the broker can return it to the service provider that transmitted it as shown in block 60.

If an offer transmitted by a service provider in block 86 is valid as determined in decision 58 the broker can serve as a proxy for receiving the offer and processing it for transmission to the user as shown in block 62. The broker can also perform its own internal transaction tracking and record keeping as shown in block 64. The broker can also filter and prioritize service provider offers as also shown in block 64, for example according to the parameters provided by the user. Thus, within block 64 the broker can assemble a list of service providers suitable for consideration by the user and transmit them to the user as shown in block 68.

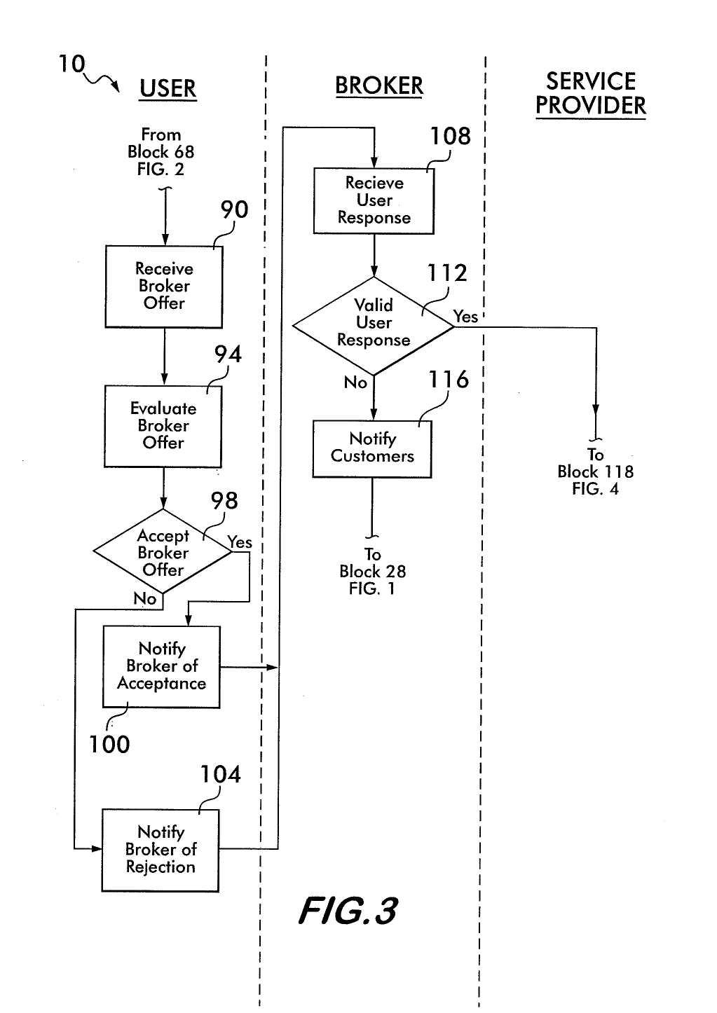

With reference to FIG. 3, the user of the data structure management system 10 can receive a broker offer, as shown in block 90. The user can evaluate the broker offer as shown in block 94, and make a determination whether to accept the broker offer as shown in decision 98. If the user decides to accept the broker offer the user can send a notification of acceptance to the broker, as shown in block 100. If the user decides to reject the broker offer the user can send a notification of rejection to the broker as shown in block 104. If the user receives offers from multiple service providers the user can transmit a request that the broker require the service providers bid against each other.

The broker receives the notification of acceptance or rejection from the user as shown in block 108. The broker can then determine whether the response received in block 108 is a valid user response as shown in decision 112. If the response received in block 108 is not valid the broker can notify the customer as shown in block 116 and allow the user to review the rejection of the offer as shown in block 28 of FIG. 1. If the user response to the broker is valid the broker can forward it to a service provider or to multiple service providers.

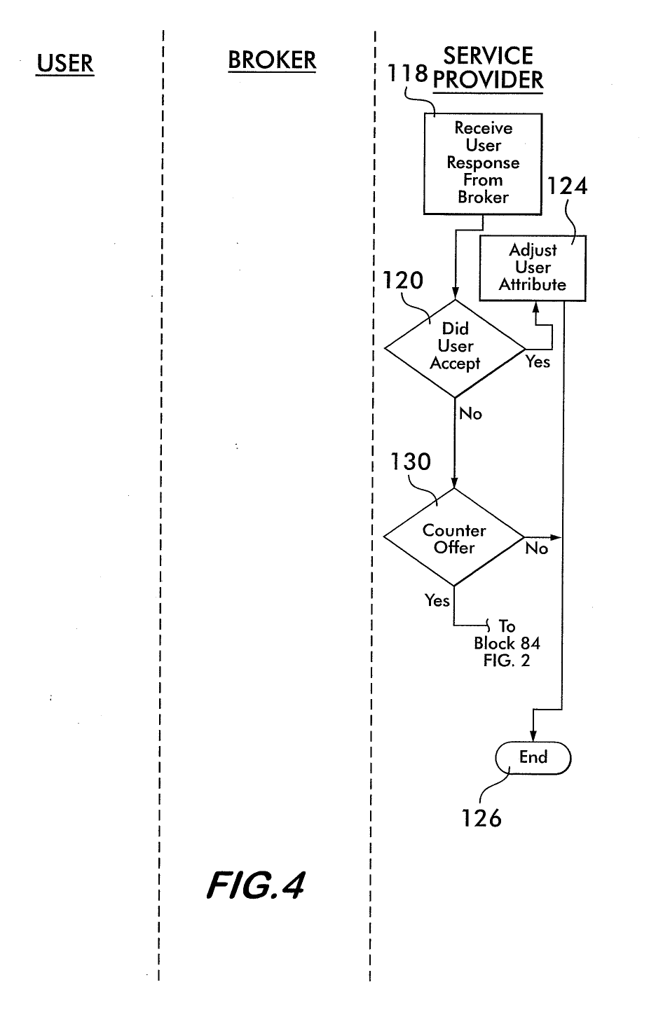

With reference to FIG. 4, if the user response within the data structure management system 10 is valid the service provider can receive the user response from the broker as shown in block 118. The service provider can determine whether the user accepts or rejects the offer as shown in decision 120. If the user accepts the offer, as determined by the service provider in decision 120, the service provider can alter a user attribute within its user attribute management data structure accordingly as shown block 124. In one preferred embodiment the service provider can insert the user into a queue data structure when performing the operations of block 124. For example, the service provider can place the user into a first-in first-out queue to hold the user in a line waiting for the service. When the user attribute within the service provider data structure is adjusted the data structure management system 10 can end as shown block 126. Furthermore, a service provider or a broker can contact the user at a later time based on the user access to the data structure.

If the user does not accept the offer, as determined in decision 120, the service provider can determine whether to make a counter offer to the user as shown in decision 130. If the service provider decides not to make a counter offer the data structure management system 10 can end as shown in block 126. If the service provider decides to make a counter offer to the user, execution of the data structure management system 10 can proceed to block 84 of FIG. 2 where the service provider can generate a new offer.

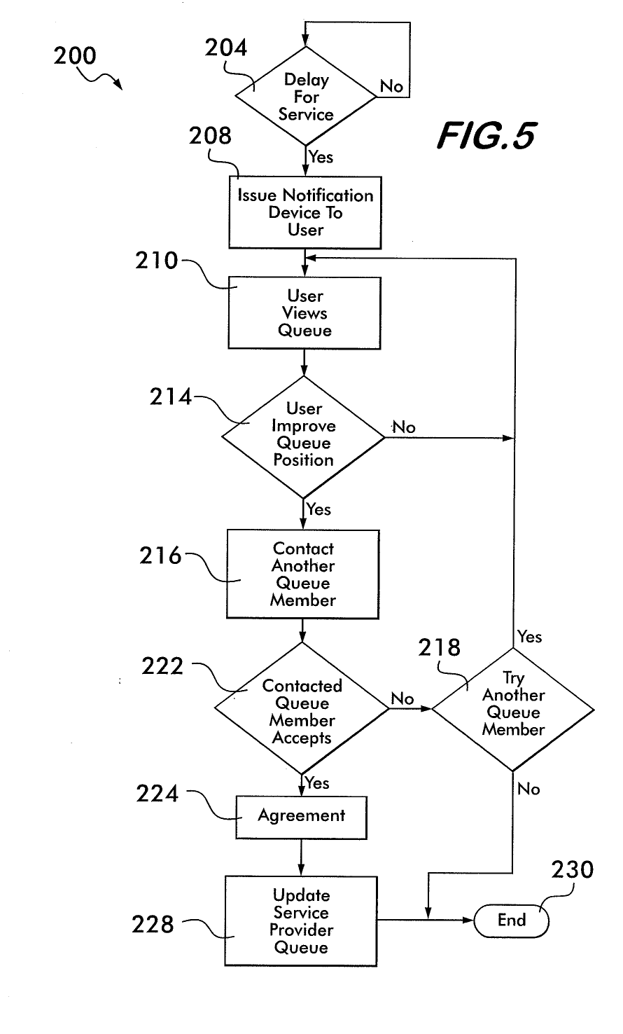

Referring now to FIG. 5, there is shown the user queue negotiation process 200 for permitting a user to perform a negotiation. The user of the user data structure management system 10 can use the user queue negotiation process 200 to negotiate with another member within a service provider data structure, with a service provider, or with any other entity. A user can negotiate with respect to user preferences or any other matter. For example, a user can negotiate with another member of the queue or with the service provider with respect to a user position within the service provider queue. Furthermore, the user queue management system 200 is not limited to use with the data structure management system 10. It can be used interactively with any other queue management system or data structure management system known to those skilled in the art.

Within the user queue negotiation process 200 when a user requests a service, a service provider registered with the data structure management system 10 can determine whether there is a delay before the request can be accommodated, as shown in decision 204. If there is a delay before the service provider can provide the requested service, the service provider can issue a notification device to the user as shown in block 208. The notification device can be any type of computing device. For example, the notification device can be a paging device or a device having a display or any other device capable of receiving notification messages and notifying the user. The service provider can use the device issued in block 208 to notify the user when the service provider is able to provide the requested service to the user. For example, if a provider of restaurant services determines that a user must wait for a table, the restaurant provider can issue a device to the user and use the device to notify the user the customer when the table is ready.

In one preferred embodiment of the invention, the notification device issued by the service provider in block 208 can include a display for displaying information to the user. For example, the display on the issued device can display an estimated wait time for the user. Additionally, the display can display representations of other members of the service queue to the user. Using the display provided in this matter, users of the user queue negotiation process 200 can determine their locations within the service provider queue relative to the other queue members represented on the display as shown in block 210.

Additionally, the issued device can provide links to other members of the queue on the display of the issued device. The links can permit the user to contact and send a message to other members of the queue. Therefore, when a user within a service provider data structure views the other members of the queue as shown in block 210, the user can make a determination whether to attempt to improve the user queue position as shown in decision 214.

The user can thus contact another queue member as shown in block 216 and offer an exchange of queue positions with the contacted queue member. The user can request a change of queue positions based on good will. Alternately, the user can barter with the contacted queue member to change positions based on value. For example, the user can offer cash for the position of the contacted queue member. Alternatively, the user can offer to electronically transfer funds to an account of the contacted queue member. The service provider can assist in the negotiation by making services available for to the queue members.

The contacted queue member can determine whether to accept the offer from the contacting user queue member as shown in decision 222. If the contacted queue member declines the offer, the contacting user can determine whether to contact another queue member as shown in decision 218. If the contacting user decides not to try another queue member the user queue negotiation process 200 can end as shown in block 230. If the contacting user decides to try another queue member, the user can again view the service provider queue as shown in block 210 and select another queue member to request an exchange of queue positions or to make some other type of offer.

If the contacted queue member decides to take the offer, as determined in decision 222, the queue members can reach an agreement as shown in block 224. If there is an agreement, the service provider can update the queue accordingly as shown in block 228. The service provider can be instructed to make the negotiated update shown in block 228 by way of the device issued to the user, by verbal instructions or by any other method. The user queue negotiation process can then end as shown in block 230.

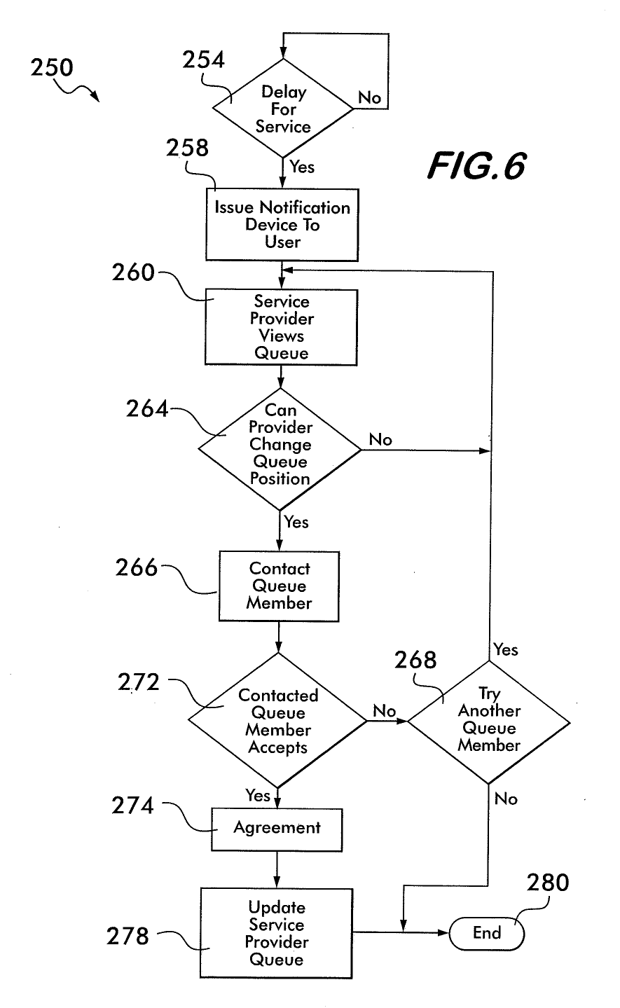

Referring now to FIG. 6, there is shown the service provider queue negotiation process 250. The provider queue negotiation process 250 is an alternate embodiment of the user queue negotiation process 200, primarily for use by a service provider rather than the queue member. A service provider can use the service provider queue negotiation process 250 to negotiate with a member of a service provider data structure to permit changes in the attributes of the member as stored within the service provider data structure.

Within the user queue negotiation process 250 when a user requests a service, a service provider can determine whether there is a delay before the request can be accommodated, as shown in decision 254. If there is a delay before the service provider can provide the requested service, the service provider can issue a notification device to the user as shown in block 258. The service provider can use the device issued in block 258 to notify the user when the service provider is able to provide the requested service to the user. The notification device can be any type of computing device, for example, a paging device.

A service provider using the negotiation process 250 can view the queue as shown in block 260 and determine whether to change the position of a user as shown in decision 264. Furthermore, the service provider can contact the member of the queue as shown in block 266 in order to suggest the change as shown in block 266. The contacted queue member can determine whether to accept the offer from the service provider as shown in decision 272. If the contacted queue member declines the offer, the service provider can determine whether to contact another queue member as shown in decision 268. If the service provider decides not to try another queue member the user queue negotiation process 250 can end as shown in block 280.

If the service provider decides to try another queue member, the service provider can again view the service provider queue as shown in block 260 and select another queue member. If the contacted queue member decides to take the offer of the service provider, as determined in decision 272, the service provider and the contacted queue member can reach an agreement as shown in block 274. If there is an agreement, the service provider can update the queue accordingly as shown in block 278. The user queue negotiation process 250 can then end as shown in block 280.

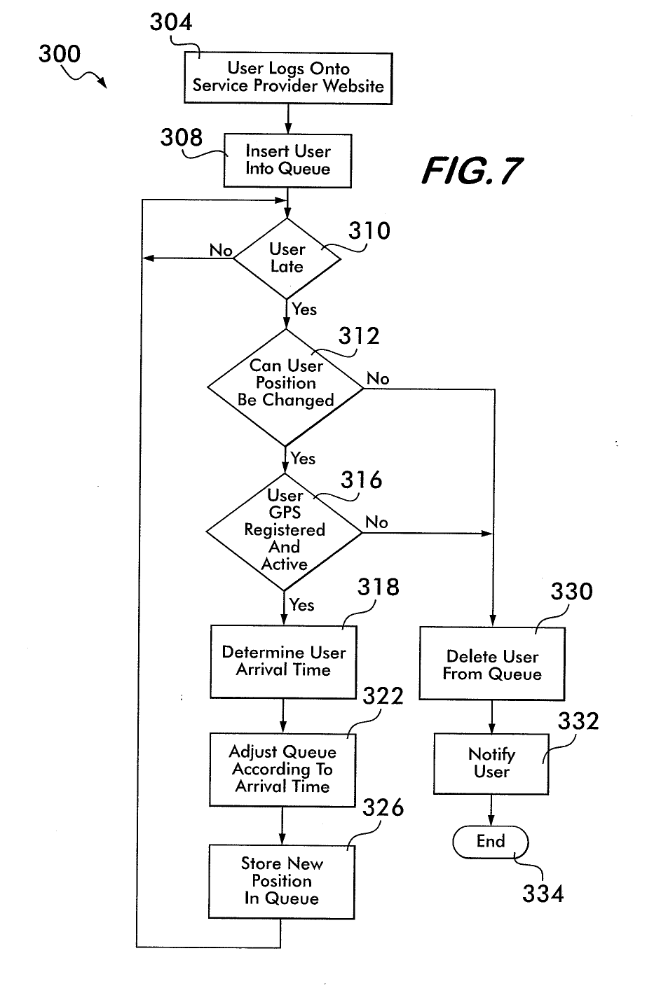

Referring now to FIG. 7, there is shown the queue repositioning process 300. A user or a service provider can use the queue repositioning process 300 to automatically reposition the user within a service provider data structure. Furthermore, a service provider can use the queue repositioning process 300 to automatically reposition the user without requesting the permission of the user at the time of the repositioning. In a preferred embodiment of the invention the process 300 can alter any user attribute in a service provider queue without requesting permission at the time of the alteration. The queue repositioning process 300 can be used in connection with the queue management process 10 or with any other queue management or data structure management system.

In one embodiment of the queue repositioning process 300 the user can log onto a web site published by a service provider having a service provider data structure as shown in block 304. The user can navigate the service provider web site to the data structure and insert a user entry or alter a user attribute in the data structure as shown in block 308. For example, the operations of block 308 can create a reservation at a restaurant for the user. In an alternate embodiment of the invention a server provider can insert the into a service provider data structure by way of a broker.

The service provider can determine whether the user is late for a reservation, for picking up tickets, or in receiving any other type of service, as shown in decision 310. Alternately, the service provider can determine that some other parameter of a user request cannot be accommodated for any other reason. If a user parameter cannot be accommodated the queue repositioning process 300 can determine whether the user has authorized the service provider to change a corresponding user attribute within the service provider queue as shown in decision 312. The user can provide the authorization for the service provider to change the user attribute by registering with the service provider at a previous time or by registering at the time the user is inserted into the queue according to block 308.

If a parameter cannot be accommodated and the service provider is not permitted to change the attribute within the service provider queue, the queue repositioning process 300 can delete the user from the service provider queue as shown in block 330. The service provider can also notify the user as shown in block 332 if possible. When the service provider deletes the user from the service provider queue the queue repositioning process 300 can end as shown in block 334.

If the user has authorized the service provider to change the user attribute within the service provider queue, as determined in decision 312, the service provider can determine whether the user has registered a user GPS with the service provider as shown in decision 316. The service provider can also determine whether the user GPS is active at the time of decision 316. If the user GPS is active the queue repositioning process 300 can estimate the time at which the user will arrive at the location of the service provider as shown in block 318. The service provider can then adjust the queue position of the user according to the determined arrival time as shown in block 332. In another preferred embodiment of the invention the service provider can alter the user attribute without the use of an estimated time of arrival based upon a user GPS. The service provider can store the new position of the user in the queue as shown in block 326. The service provider can make further determinations with respect to user attributes in view of the altered queue according to decision 310.

Accordingly, a service provider can automatically adjust a user attribute according to a determination with respect to any criteria. For example, the service provider can alter an attribute if the service provider is behind schedule, if the service provider wants to give priority to the user or to other users of the service, or according to any other criteria.

It will be understood by those skilled in the art that any application programs implementing the data structure management system 10, the user queue negotiation process 200, the service provider queue negotiation process 250 and the queue repositioning process 300, or any portions thereof, can be installed on and can operate on any computing device. For example, portions of the foregoing processes can operate on a wireless handheld device such as a personal digital assistant, a smart phone, a portable device such as a laptop, a device that is not portable such as a personal computer, a web based device, or any other device that can permit a user to interact with the managed data structure. A computing device running an application implementing features of the data structure management system 10 can be a wireless device or a hard wired device. Alternately, any portion of the software implementing the foregoing processes can operate upon a computing device such as a server provided by a broker, a service provider, or any other device suitable for hosting the applications, while other portions can operate on other devices.

While the invention has been described in detail and with reference to specific examples thereof, it will be apparent to one skilled in the art that various changes and modifications can be made therein without departing from the spirit and scope thereof.

What is claimed is:

1. A method for managing an attribute of a user of a service provided by a service provider, said user having a user computing device and said service provider having a service provider computing device, comprising:
providing a user attribute management data structure for managing a user attribute within said service provider computing device;
providing interaction between said user attribute management data structure and said user using said user computing device; and
altering said user attribute management data structure in accordance with said interaction using said service provider computing device.

2. The method for managing an attribute of a user according to claim 1, wherein said user has a user attribute stored in said user attribute management data structure further comprising altering said user attribute management data structure by altering said user attribute.

3. The method for managing an attribute of a user according to claim 2, wherein said user attribute comprises a user place in a line attribute representative of a user place in a line waiting for said service.

4. The method for managing an attribute of a user according to claim 2, further comprising further altering said user attribute by said user.

5. The method for managing an attribute of a user according to claim 2, further comprising further altering said user attribute by said service provider.

6. The method for managing an attribute of a user according to claim 5, further comprising further altering said user attribute in accordance with a service provider criterion.

7. The method for managing an attribute of a user according to claim 1, further comprising:
transmitting a user request by said user;
receiving said user request by said service provider to provide a received user request; and
providing a service provider offer to said user by said service provider in accordance with said received user request.

8. The method for managing an attribute of a user according to claim 7, further comprising rejecting said service provider offer by said user.

9. The method for managing an attribute of a user according to claim 8, further comprising generating a new offer by said service provider.

10. The method for managing an attribute of a user according to claim 1, further comprising interacting with said user attribute management data structure by way of a broker.

11. The method for managing an attribute of a user according to claim 10, further comprising registering with said broker by said service provider.

12. The method for managing an attribute of a user according to claim 11, further comprising;
receiving a user request from said user by said broker to provide a received user request; and
sending said received user request to said service provider by said broker in accordance with said registering.

13. The method for managing an attribute of a user according to claim 1, further comprising providing a user parameter by said user.

14. The method for managing an attribute of a user according to claim 13, wherein said user parameter comprises a time parameter.

15. The method for managing an attribute of a user according to claim 13, wherein said user parameter comprises a geographic location parameter.

16. The method for managing an attribute of a user according to claim 13, wherein said user parameter comprises a price parameter.

17. The method for managing an attribute of a user according to claim 13, further comprising altering said user attribute management data structure in accordance with said user parameter.

18. The method for managing an attribute of a user according to claim 17, further comprising altering said user attribute management data structure in accordance with a plurality of said user parameters.

19. The method for managing an attribute of a user according to claim 1, further comprising:
providing first and second users having respective user attributes stored in said user attribute management data structure;
one of said first and second users making an contacting the other of said first and second users; and
altering at least one of said respective user attributes in response to said contacting.

20. The method for managing an attribute of a user according to claim 19, further comprising making an offer requiring altering both of said respective user attributes.

21. A method for managing an attribute of a user of a service provided by a service provider, comprising:
providing a service provider computing device for storing a user attribute management data structure to manage a user attribute within said user attribute management data structure;
interacting with said user by said service provider computing device; and
altering said user attribute by said service provider computing device in accordance with said interacting.
